(19) United States
(12) Patent Application Publication
(10) Pub. No.: US 2004/0085758 A1
(43) Pub. Date: May 6, 2004

(54) Electric decorative flower

(76) Inventor: David Deng, Chino Hills, CA (US)

Correspondence Address: JOE NIEH, 18760 E. AMAR ROAD #204, WALNUT, CA, 91789, US

(21) Appl. No.: 10/285,275

(22) Filed: Oct. 31, 2002

(51) Int. Cl. F21S 6/00

(52) U.S. Cl. 362/122; 362/806

(57) ABSTRACT

The electric decorative flower is a lighting means for artificial flowers. The electric decorative flower comprises of a small light source enclosed within the artificial flower to illuminate the artificial flower from within to enhance the three-dimensional depth and aesthetic appeal of the artificial flower. The electric decorative flower comprises of an artificial flower assembled around a small light source such as a small light bulb or a light-emitting diode (LED). After assembly of the artificial flower, the small light source will be generally enclosed in the middle of the artificial flower. The small light source may be connected to a power source through wires enclosed within the stems of the artificial flowers, hidden from view. When power is applied to the small light source, it will emit light that illuminates the flower from within to give it a soft glow. This illumination effect is particularly attractive at night or in low-light conditions. The light source may be turned on or off as desired.

### BACKGROUND-FIELD OF INVENTION

The present invention relates generally to artificial flowers. More specifically, the present invention relates to artificial flowers with decorative lighting.

### BACKGROUND-DESCRIPTION OF RELATED ART

Flowers are beautiful to look at but they last for a relatively short period of time. Various types of artificial flowers were developed to mimic the look and feel of the real flower. The artificial flower may be made of paper, fabric, silk, plastic, glass, or a variety of other suitable materials. The artificial flower lasts virtually forever and requires virtually no maintenance and no watering, unlike real flowers. Its life expectancy generally limited by the material used to create the artificial flower. Current state of the art artificial flowers can be almost indistinguishable from real flowers and are replacing real flowers in a variety of applications. Most commonly, the artificial flowers are used indoors for decorative purposes.

Various modifications to and accessories for the artificial flowers are designed to enhance the aesthetic appeal and uniqueness of the artificial flowers. Some modifications include addition of various lighting effects to enhance the appearance of the artificial flowers. Generally the lighting effects comprise of shining a light source on the exterior surface of the artificial flowers to enhance the depth and three-dimensional appearance of the artificial flower. The light also enhances the visibility and aesthetic appeal of the artificial flowers at night or in low-light indoor environments.

### SUMMARY OF THE INVENTION

The present invention is a lighting means for artificial flowers. The present invention comprises of a small light source enclosed within the artificial flower to illuminate the artificial flower from within to enhance the three-dimensional depth and aesthetic appeal of the artificial flower. The present invention comprises of assembling the artificial flower around a small light source such as a small light bulb or a light-emitting diode (LED). After assembly of the artificial flower, the small light source will be generally enclosed in the middle of the artificial flower. The small light source may be connected to a power source through wires enclosed within the stems of the artificial flowers, hidden from view. When power is applied to the small light source, it will emit light that illuminates the flower from within to give it a soft glow. This illumination effect is particularly attractive at night or in low-light conditions. The light source may be turned on or off as desired.

### BRIEF DESCRIPTION OF THE DRAWINGS

FIG. 1 shows the completely assembled artificial flower on a stem with the small light source enclosed within the artificial flower.

FIG. 2 shows another completely assembled artificial flower on a stem with the small light source enclosed within the artificial flower.

FIG. 3 shows another completely assembled artificial flower on a stem with the small light source enclosed within the artificial flower.

FIG. 4 shows the assembly of the artificial flower and its stem.

FIG. 5 shows the assembly of a multi-layer artificial flower and the small light source within it.

FIG. 6 shows the assembly of a single-layer artificial flower and the small light source within it.

FIG. 7 shows the assembly of the small light source.

FIG. 8 shows the components of the small light source.

FIG. 9 shows the assembly and components of a small light source with multiple light bulbs for a multi-layer artificial flower.

FIG. 10 shows the assembly and components of a small light source with multiple light bulbs for a single-layer artificial flower.

FIG. 11 shows the stem of the artificial flower with two branches.

FIG. 12 shows the stem of the artificial flower with three branches.

FIG. 13 shows the cross-sectional views of the stems of the artificial flower.

### DETAILED DESCRIPTION OF THE PREFERRED EMBODIMENT

In the preferred embodiment of the present invention, the electric decorative flower comprises of a small light source such as a small light bulb or a light-emitting diode (LED) enclosed within an artificial flower with its base physically attached and in electrical connection with the stem at the base of the artificial flower. The small light source is electrically connected to a power source through wires enclosed within the stems of the artificial flowers. The power source may be alternating-current (AC) or direct-current (DC) electrical power. The small light source may be controlled by a switch or remotely with a remote control.

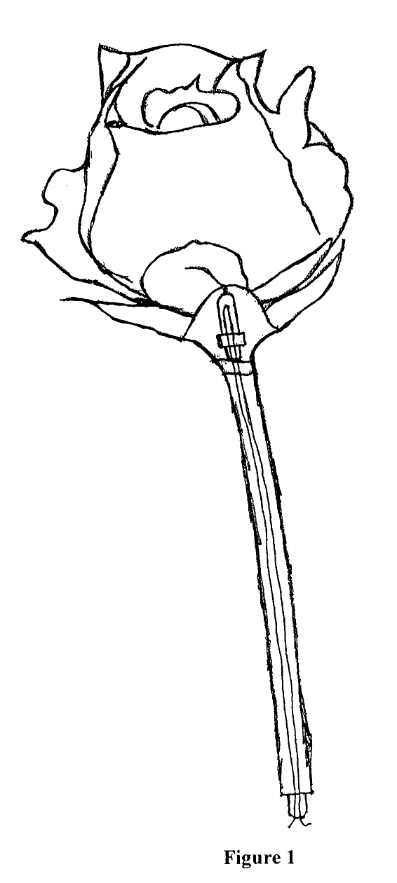

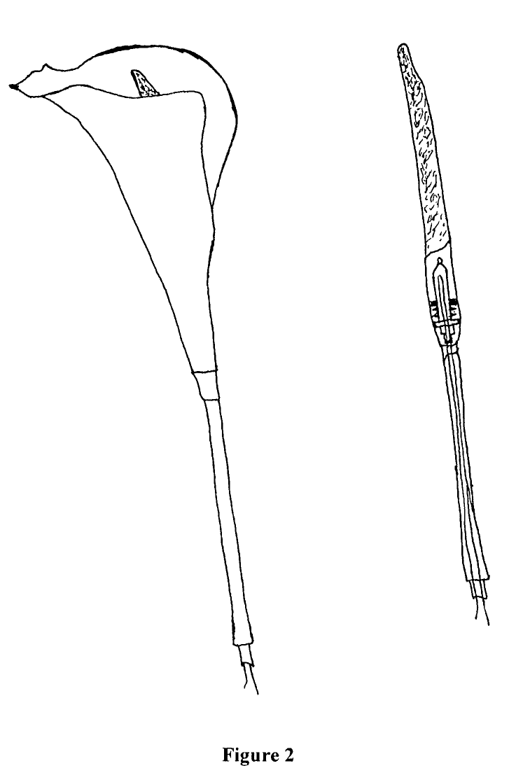

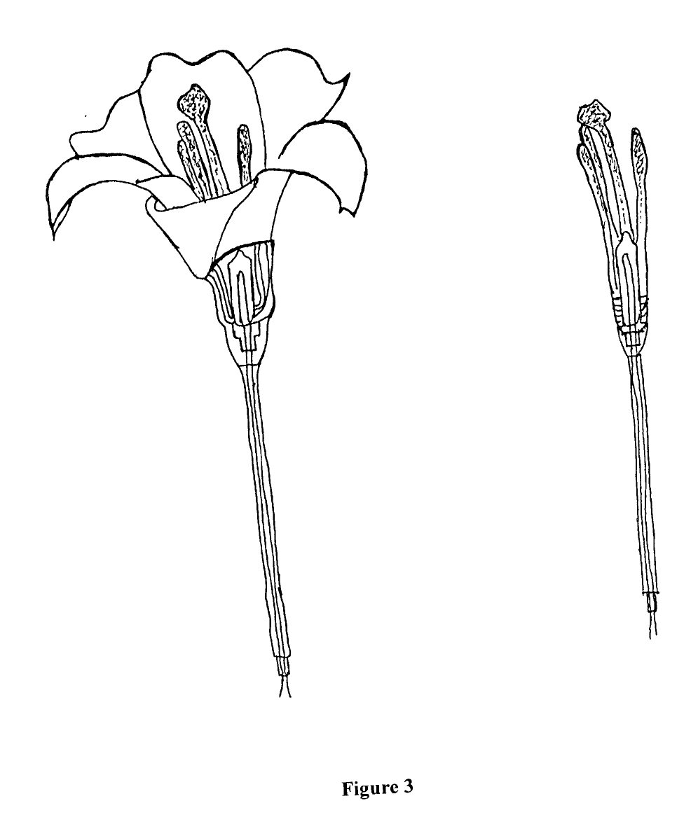

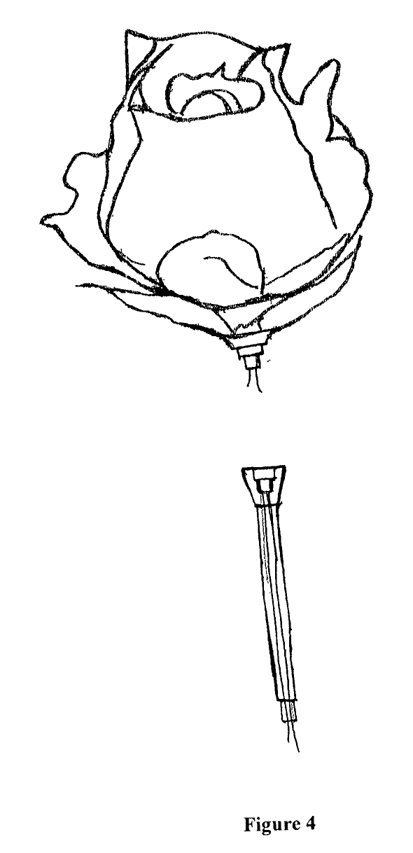

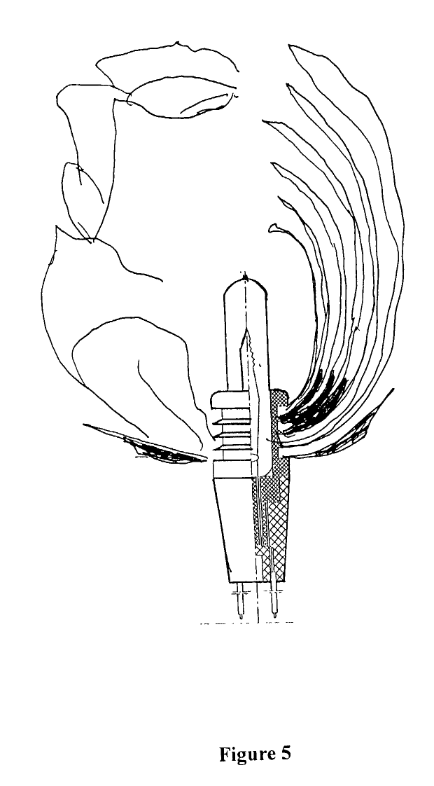

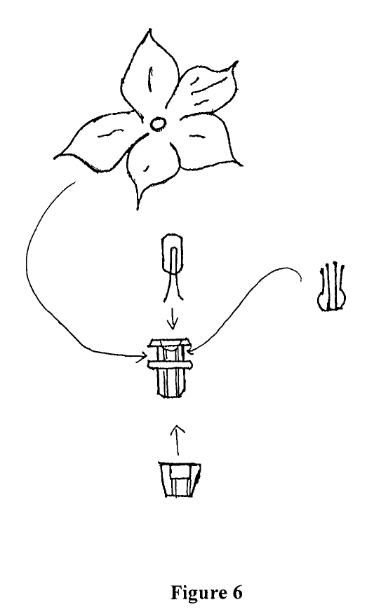

FIGS. 1, 2, and 3 show a variety of artificial flowers completely assembled on a stem with the small light source enclosed within the artificial flower. FIG. 4 shows the attachment and electrical connection of the artificial flower and its stem wherein the flower and the small light source are physically attached to the stem and the small light source is in electrical connection with the wires enclosed within the stem. FIG. 5 shows the assembly of a multi-layer artificial flower and the small light source within it wherein the artificial flower comprises of multiple layers that are assembled around a small light source. FIG. 6 shows the assembly of a single-layer artificial flower and the small light source within it wherein the artificial flower comprises of only a single layer that is assembled around a small light source.

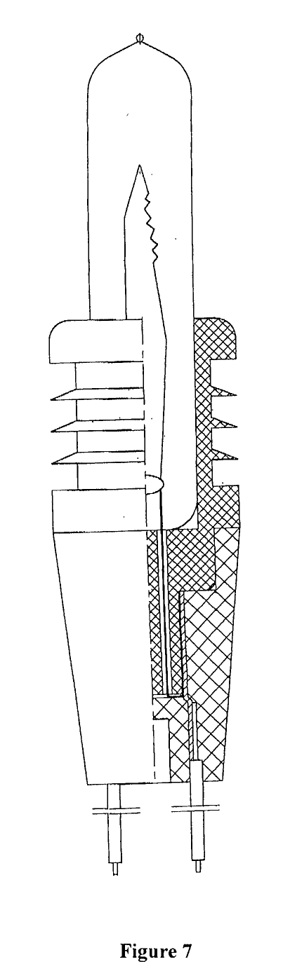

FIG. 7 shows the assembly of the small light source wherein the light bulb or the light-emitting diode (LED) is inserted into a socket that receives the base of the light bulb or the LED and electrically connected to the electrical contacts at the base of the light bulb or the LED.

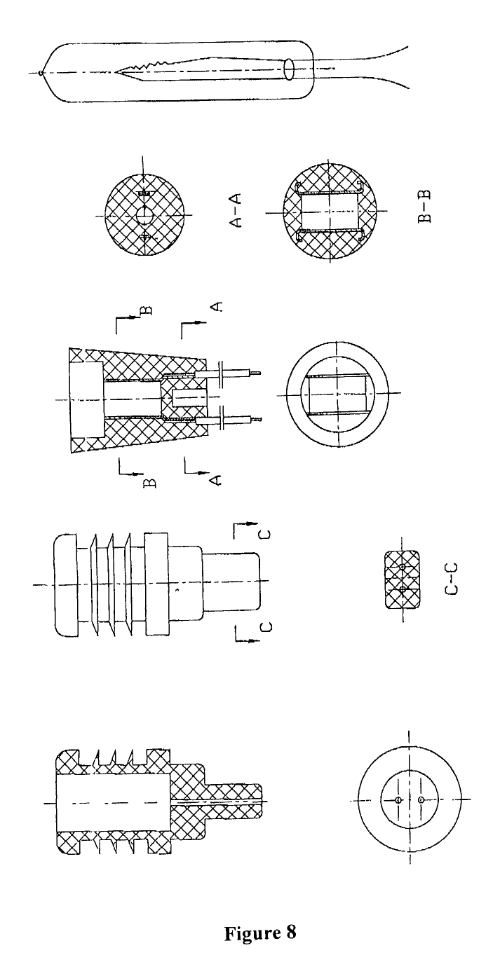

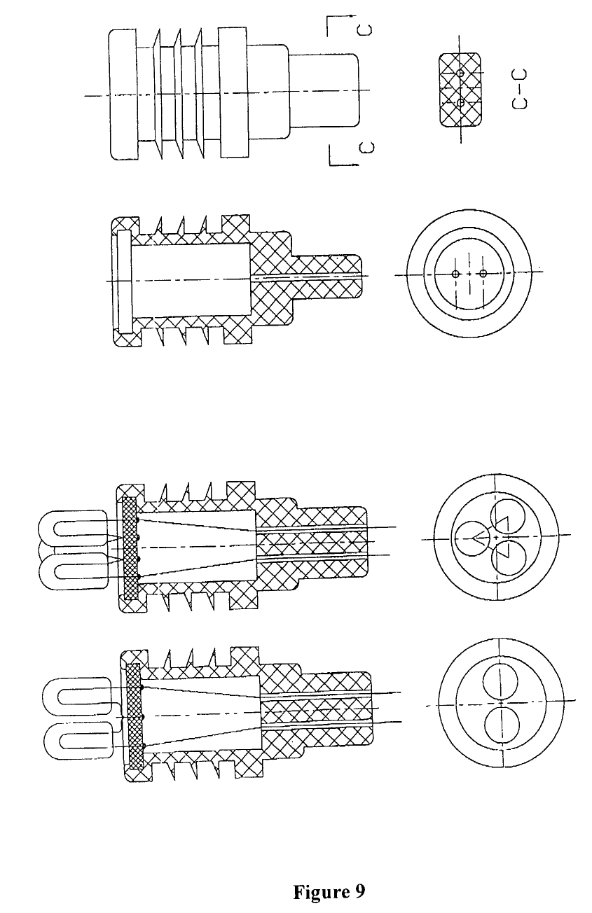

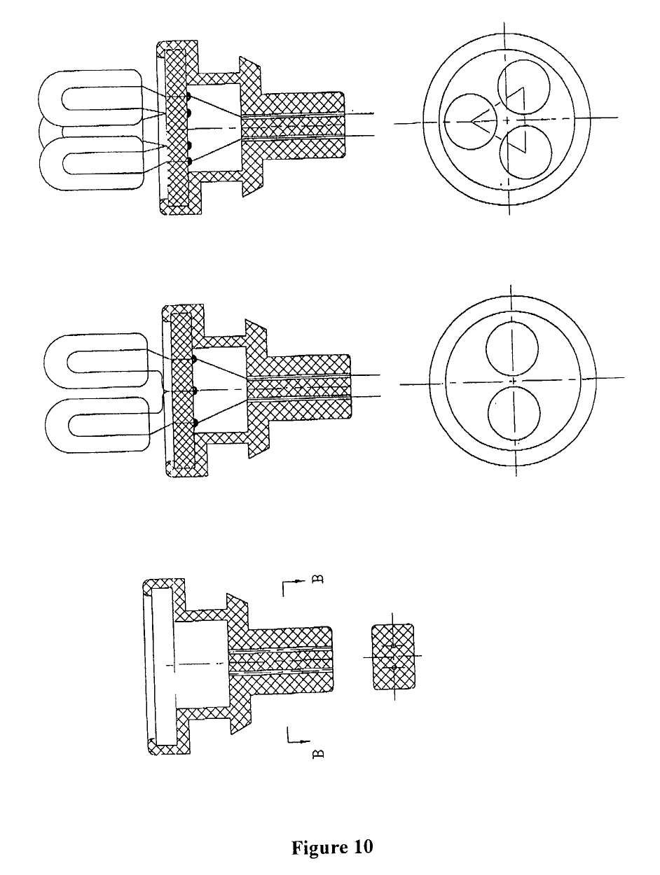

FIG. 8 shows the components of the small light source wherein the small light source comprises of a light bulb or a light-emitting diode (LED) and a plastic socket for receiving the base of the small light source and to electrically connect the small light source to the wires enclosed within the stem. FIG. 9 shows the assembly and components of a small light source wherein multiple light bulbs or light-emitting diodes (LED) are attached and electrically connected to a single socket for a multi-layer artificial flower. FIG. 10 shows the assembly and components of a small light source wherein multiple light bulbs or light emitting-diodes (LED) are attached and electrically connected to a single socket for a single-layer artificial flower.

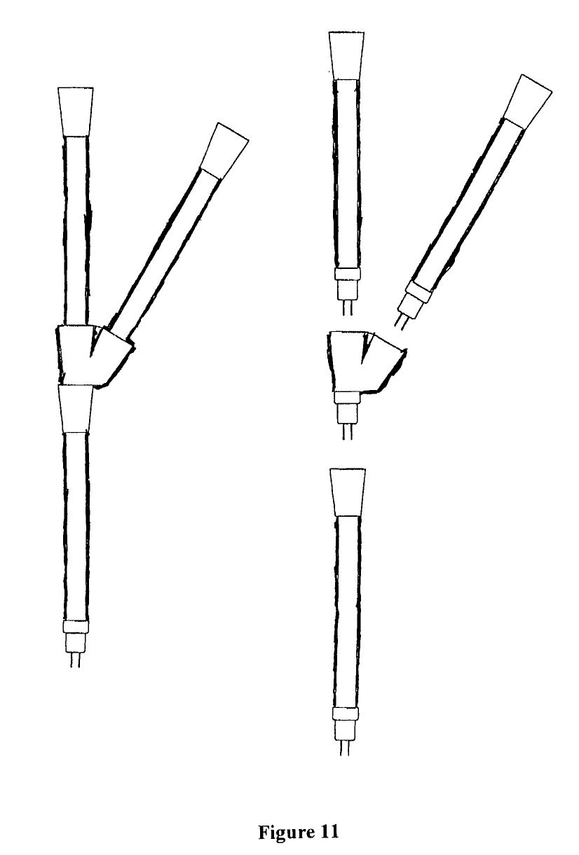

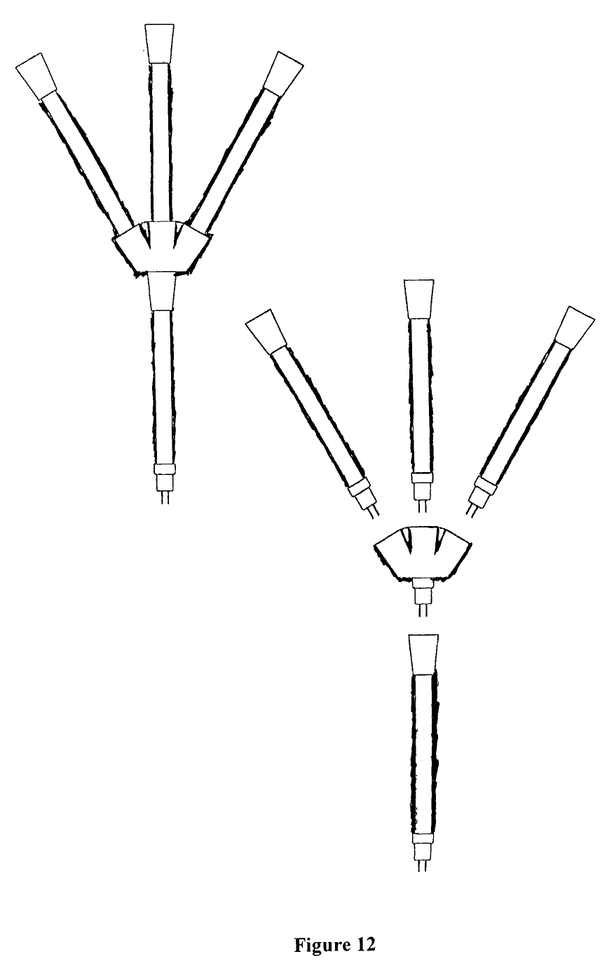

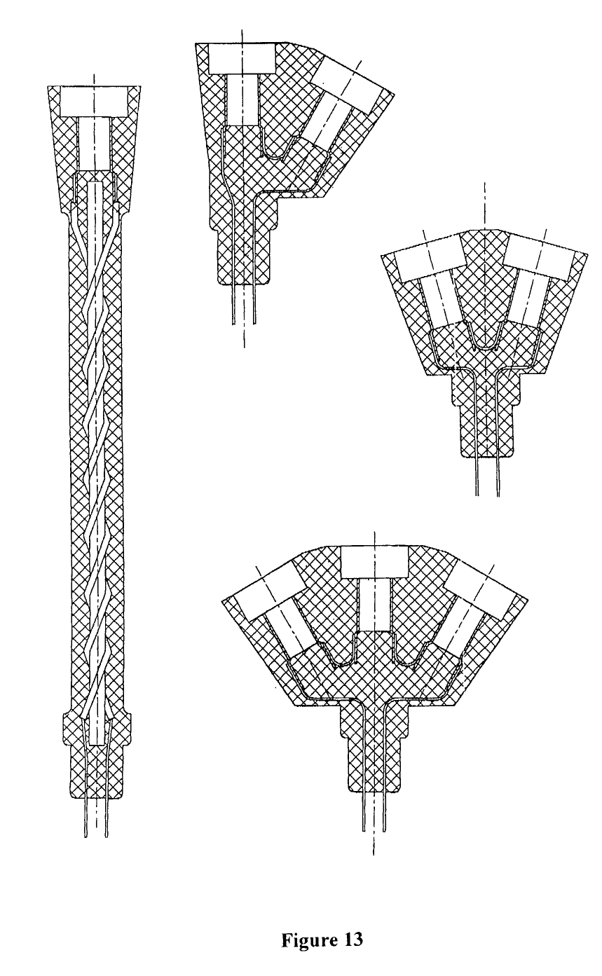

FIG. 11 shows the stem of the artificial flower with two branches attached to the stem with a two-branch joint wherein two artificial flowers may be attached to each end of the branches. FIG. 12 shows the stem of the artificial flower with three branches attached to the stem with a three-branch joint wherein three artificial flowers may be attached to each end of the branches. The two-branch joint and the three-branch joint may be used interchangeably and in combination to achieve the desired branch pattern and for attachment of the desired number of artificial flowers to one or more stems. FIG. 13 shows the cross-sectional views of the stem and the branch joints for the artificial flower. Within each branch, branch joint, and stem are two wires with electrical contact at each end of the branch, branch joint, and stem to electrically connect the small light source with the power source. The small light source may be turned on or off with a switch or a remote controlled switch.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. An electric decorative flower comprising:
an artificial flower; and
a light source attached generally to the center of the artificial flower and inserted into a stem that electrically connects the light source to a power source;
wherein when power is applied to the light source, it will emit light that illuminates the flower from within to give it a soft glow.

2. An electric decorative flower according to claim 1, wherein the artificial flower only has one layer.

3. An electric decorative flower according to claim 1, wherein the artificial flower has multiple layers.

4. An electric decorative flower according to claim 1, wherein the light source is a light bulb.

5. An electric decorative flower according to claim 1, wherein the light source is a light-emitting diode.

6. An electric decorative flower according to claim 2, wherein the light source is a light bulb.

7. An electric decorative flower according to claim 3, wherein the light source is a light bulb.

8. An electric decorative flower according to claim 2, wherein the light source is a light-emitting diode.

9. An electric decorative flower according to claim 3, wherein the light source is a light-emitting diode.

10. An electric decorative flower comprising:
an artificial flower; and
a light source attached generally to the center of the artificial flower and inserted into a branch that physically and electrically connects the light source to a branch joint which in turn physically and electrically connects to a stem that physically and electrically connects to a power source;
wherein when power is applied to the light source, it will emit light that illuminates the flower from within to give it a soft glow.

11. An electric decorative flower according to claim 10, wherein the light source is a light bulb.

12. An electric decorative flower according to claim 10, wherein the light source is a light-emitting diode.

13. An electric decorative flower according to claim 10, wherein the branch joint has two connections for the branch.

14. An electric decorative flower according to claim 10, wherein the branch joint has three connections for the branch.

15. An electric decorative flower according to claim 11, wherein the branch joint has two connections for the branch.

16. An electric decorative flower according to claim 12, wherein the branch joint has two connections for the branch.

17. An electric decorative flower according to claim 11, wherein the branch joint has three connections for the branch.

18. An electric decorative flower according to claim 12, wherein the branch joint has three connections for the branch.

19. An electric decorative flower according to claim 10, wherein the light source comprises of multiple light bulbs.

20. An electric decorative flower according to claim 10, wherein the light source comprises of multiple light-emitting diodes.

21. An electric decorative flower comprising:
an artificial flower; and
a light source comprising multiple light bulbs attached generally to the center of the artificial flower and inserted into a stem that electrically connects the light source to a power source;
wherein when power is applied to the light source, it will emit light that illuminates the flower from within to give it a soft glow.

22. An electric decorative flower comprising:
an artificial flower; and
a light source comprising multiple light-emitting diodes (LED) attached generally to the center of the artificial flower and inserted into a stem that electrically connects the light source to a power source;
wherein when power is applied to the light source, it will emit light that illuminates the flower from within to give it a soft glow.
